(19) United States
(12) Patent Application Publication
(10) Pub. No.: US 2017/0321792 A1
(43) Pub. Date: Nov. 9, 2017

(54) FUSION GEAR REDUCER

(71) Applicants: CHIA-SHENG LIANG, Taipei City (TW); PRODRIVES & MOTIONS CO., LTD., Taipei City (TW)

(72) Inventors: CHIA-SHENG LIANG, TAIPEI CITY (TW); SZU-MING HUANG, TAIPEI CITY (TW)

(21) Appl. No.: 15/585,765

(22) Filed: May 3, 2017

(30) Foreign Application Priority Data
May 3, 2016 (TW) 105113712

(51) Int. Cl. F16H 49/00; F16H 37/04; F16H 57/08; F16H 1/28

(52) U.S. Cl. CPC F16H 49/001; F16H 57/08; F16H 1/28; F16H 37/041; F16H 2049/003

(57) ABSTRACT

A fusion gear reducer includes a first-stage gear reduction unit and a second-stage gear reduction unit both in a housing. The first-stage gear reduction unit includes a sun gear, a planet gears support, planet gears spaced around the sun gear and meshed therewith, and a ring gear around the planet gears and meshed therewith. The second-stage gear reduction unit includes spaced rollers arranged as a circle, roller grooves, wells formed on an inner surface of the housing, and a cam surface formed on an outer surface of the ring gear so that the ring gear is output of the first-stage gear reduction unit and input of the second-stage gear reduction unit. The roller grooves are disposed on outer surfaces of the planet gears so that the planet gears are output of the second-stage gear reduction unit. The simplified fusion gear reducer solves the problem of bulkiness of gear reducer.

### BACKGROUND OF THE INVENTION

### 1. Technical Field

The invention relates to gear reducers and more particularly to a fusion gear reducer including an epicyclic gear train and a wave-driven speed reducer.

### 2. Related Art

Gear reducers are used to decrease rotational speed and increase torque in output. Worm gear drives, epicyclic gear trains and harmonic drives are common conventional reducers.

A worm gear drive type reducer includes a worm shaft as input meshing with a worm gear as output.

An epicyclic gear train type reducer includes a set of epicyclic gear train for generating a reduced speed output. Taiwan Utility Model Numbers M331,061, M434,857, and M454,479 all disclose an epicyclic gear train type reducer coaxially mounted with the input shaft. Specifically, Both of Taiwan Utility Model Numbers M331,061 and M434,857 disclose a mounting technique of a single stage epicyclic gear train in speed reducer, while Taiwan Utility Model Number M454,479 discloses a mounting technique of a two-stage epicyclic gear train type in speed reducer.

A harmonic drive reducer transmits the power by generating a strain wave. U.S. Pat. No. 2,906,143 entitled “Strain wave gearing” by Musser is the first disclosing the harmonic drive in 1955. Further, U.S. Pat. No. 5,643,128 entitled “Harmonic drive using guided, floating cam driven cylinders as power transmitting elements” by Kennedy discloses the mechanism details of the harmonic drive.

A conventional harmonic drive composed coaxially by a cam (or named as “wave generator”), a plurality of rollers sitting around the cam and a circular spline wheel with specific profile from inside out. Generally, the cam is used as a power input shaft and the rollers are circularly arranged between the cam and the circular spline wheel. The circular spline wheel has a plurality of wells arranged as a rim for receiving the rollers every cycle. The cam activates to drive some rollers disposed in the wells. As a result, a reduced speed output is generated by the output ring.

Besides, there is a reducer including an epicyclic gear train and a harmonic drive. It is capable of generating a multi-stage speed reduction output to meet the requirement.

However, all of above conventional gear reducers are disadvantageous due to bulkiness, an excessive axial length of the input shaft, excessive number of components, and complicated construction occupying much space. Thus, they are not desirable in terms of compactness and simplification.

### BRIEF SUMMARY

It is therefore one object of the invention to provide a fusion gear reducer including an epicyclic gear train and a wave-driven speed reducer so as to eliminate disadvantages such as bulkiness.

It is therefore an object of the invention to provide a fusion gear reducer comprising a first-stage gear reduction unit and a second-stage gear reduction unit in a housing. The first-stage gear reduction unit assembly is an epicyclic gear train, including a planet gears support, a sun gear as an input, a plurality of planet gears equally spaced around the sun gear and meshed therewith, and a ring gear disposed around the planet gears and meshed therewith. The second-stage gear reduction unit is a wave-driven speed reducer, including a plurality of equally spaced rollers arranged as a circle, a plurality of roller grooves, a plurality of wells formed on an inner surface of the housing, and a cam surface. The cam surface is formed on an outer wall of the ring gear, so the ring gear become an output of the first-stage gear reduction unit and an driving input of the second-stage gear reduction unit. The roller grooves are disposed between the cam surface and the wells. The rollers are circularly disposed in the roller grooves and confined by the cam surface, the wells, and the roller grooves as well. The rollers rotate the roller grooves; wherein the roller grooves are formed on an outer surface of the planet gears support; and wherein the planet gears support is an output of the second-stage gear reduction unit.

Preferably, the sun gear, the cam surface, and the roller grooves have a common axis and they are configured to rotate around the common axis.

Preferably, the roller grooves are disposed between the cam surface and the wells having the rollers partially disposed therein. Preferably, the rollers are pushed by the cam surface to partially dispose in the wells to rotate the roller grooves. Preferably, the cam surface has at least one convex arc member, and wherein the rollers are pushed by the arc member to partially dispose in the wells to rotate the roller grooves.

By utilizing the fusion gear reducer of the object of the invention, the following advantages are obtained: greatly increasing gear reduction ratio in a limited space, simplifying the construction of the fusion gear reducer, and rendering a compact design.

### BRIEF DESCRIPTION OF THE DRAWINGS

These and other features and advantages of the various embodiments disclosed herein will be better understood with respect to the following descriptions and drawings, in which like numbers refer to like parts throughout, and in which:

FIG. 1 is an exploded view of a fusion gear reducer according to the invention;

FIG. 2 is a longitudinal section view of the assembled fusion gear reducer;

FIG. 3 is a section view along line A-A of FIG. 2;

FIG. 4 is a partial close view of FIG. 3 showing the roller disposed between the well and the ring gear; and

FIG. 5 is a view similar to FIG. 3 showing a force balance among the cam surface, the rollers, the roller grooves, and the wells.

### DETAILED DESCRIPTION

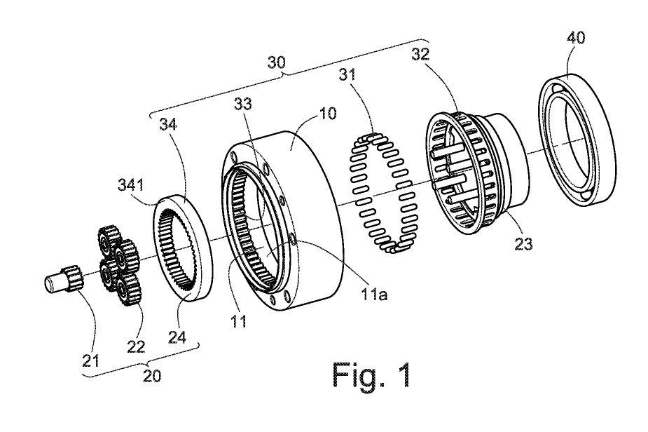

Referring to FIGS. 1 to 3, a fusion gear reducer in accordance with a preferred embodiment of the invention comprises a housing 10, a first-stage gear reduction unit 20, and a second-stage gear reduction unit 30 as discussed in detail below.

The housing 10 includes an axial space 11. The housing 10 is a fixed device for mounting the speed reducer on the equipment. Further, the housing 10 is also used as a mounting seat for the first-stage gear reduction unit 20 and the second-stage gear reduction unit 30 of the fusion gear reducer in the space 11.

The first-stage gear reduction unit 20 is implemented as an epicyclic gear train including a sun gear 21, a plurality of planet gears 22 and a ring gear 24. The sun gear 21 is the power input of the fusion gear reducer. Specifically, the sun gear 21 is attached to a rotational shaft of a drive (not shown) such as motor. More specifically, the motor is a servo motor or a step motor. The motor can rotate the sun gear 21 in operation.

The planet gears 22 are equally spaced around the sun gear 21 and mesh therewith. As shown, the planet gears 22 rotate around four axes of a planetary carrier 23 which is circularly disposed in the space 11 by a ring shaped bearing member 40.

The ring gear 24 is disposed around the planet gears 22 and meshes therewith. That is, the planet gears 22 are disposed between the sun gear 21 and the ring gear 24. The sun gear 21 driven by actuator causes the planet gears 22 to rotate by their own axes and revolute around the sun gear 21. And in turn, the ring gear 24 rotates simultaneously.

The second-stage gear reduction unit 30 is implemented as a wave-driven speed reducer including a plurality of equally spaced rollers 31 arranged as a circle, a plurality of roller grooves 32, a plurality of wells 33, and a wavy cam surface 34 on an outer surface of the ring gear 24 to serve as a mounting seat of the housing 10 as well as a seat of the wells 33. The cam surface 34 are formed on the outer surface of the ring gear 24. The roller grooves 32 are disposed between the cam surface 34 and the wells 33. The rollers 31 are rotatably disposed in the roller grooves 32 and are confined by the cam surface 34, the wells 33 and the roller grooves 32.

Specifically, the cam surface 34 includes at least one convex arc member 341 formed of spline on either annular, outer edge. The convex arc member 341 bears the force applied by the rotating rollers 31 and thus shapes as a wave. In the embodiment, the rollers 31 are cylindrical. In the other embodiments, the rollers 31 are spherical. The roller grooves 32 are formed on an outer surface of the planetary carrier 23. The planetary carrier 23 functions as a seat of the roller grooves 32. As a result, the planetary carrier 23 serves as an output of the second-stage gear reduction unit 30. Further, the cam surface 34 is formed on the outer surface of the ring gear 24 and the roller grooves 32 are formed on the outer surface of the planetary carrier 23. Thus, the sun gear 21, the cam surface 34 and the roller grooves 32 have a common axis and they rotate around the common axis in operation.

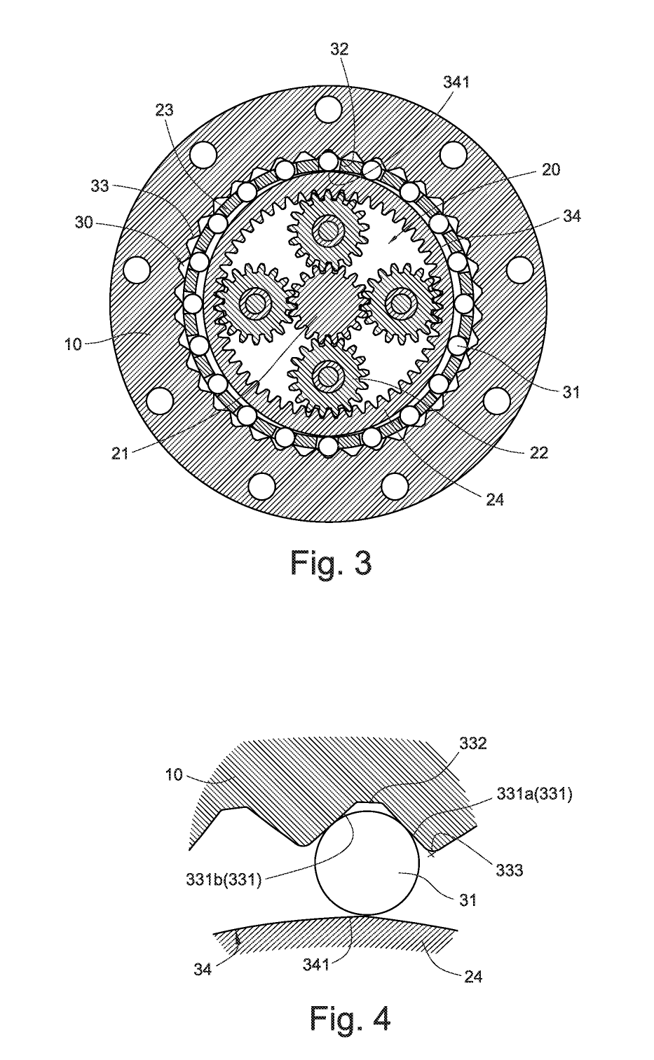

Referring to FIG. 4 in conjunction with FIGS. 1 to 3, it is an enlarged view of a portion of FIG. 3 showing the roller 31 disposed between the well 33 and the cam surface 34 of the ring gear 24. As shown in the embodiment, the rollers 31 are rotatably supported by the convex arc members 341 of the cam surface 34 and two contour surfaces 331 of the well 33. And in turn, the rollers 31 are rotated by the convex arc members 341 of the cam surface 34 and rotatably contact the contour surfaces 331 of the well 33. And in turn, the roller grooves 32 are rotated. As a result, the planetary carrier 23 is rotated to generate an output having a decreased rotational speed.

The contour surfaces 331 include a first contour surface 331a and a second contour surface 331b at an angle with respect to the first contour surface 331a. A valley 332 is formed between the first contour surface 331a and the second contour surface 331b. A curved ridge 333 is formed between two adjacent wells 33, i.e., between the first contour surface 331a of one well 33 and the second contour surface 331b of the other well 33. The wells 33 are formed on the inner surface 11a of the housing 10 as shown in FIG. 1.

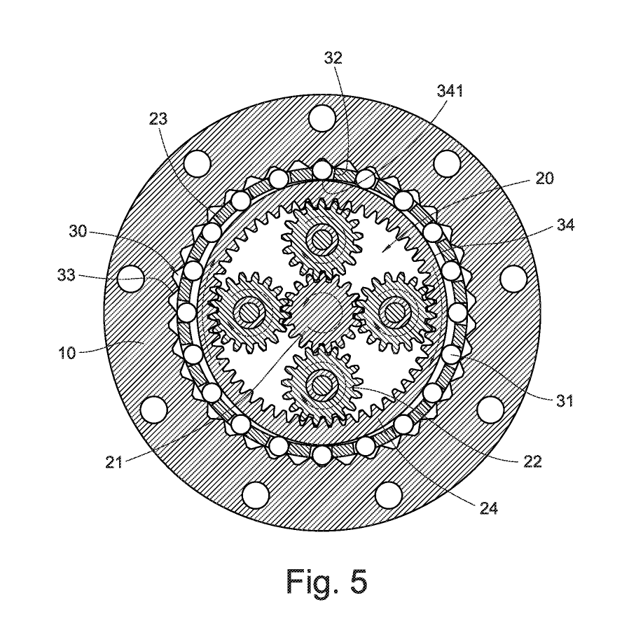

Referring to FIG. 5, when the cam surface 34 pushes the roller 31 against the first contour surface 331a and the second contour surface 331b of the well 33, a sufficient force is applied on the roller 31 by the first contour surface 331a and the second contour surface 331b. Also, the force applied on the roller 31 by the first contour surface 331a and the second contour surface 331b in the well 33 transmits to the roller 31 through the cam surface 34. Therefore, the transmission accuracy and the efficiency of the wave-driven speed reducer are improved. And in turn, transmission of the wave-driven speed reducer is more precise.

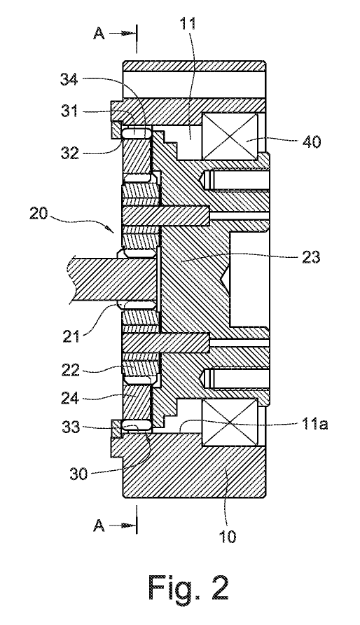

As shown in FIGS. 2 and 5, force transmitted by both the first-stage gear reduction unit 20 and the second-stage gear reduction unit 30 is described in detail below. The planet gears 22 driven by the sun gear 21 (i.e., the input) rotate about their own axes. The planet gears 22 not only mesh the ring gear 24 but also rotate the planetary carrier 23. Thus, the ring gear 24 is the output of the first-stage gear reduction unit 20 and the input for driving the second-stage gear reduction unit 30. In detail, the planetary carrier 23 is an idler while transmitting power from the first-stage gear reduction unit 20 to the second-stage gear reduction unit 30. With respect to the first-stage gear reduction unit 20, the ring gear 24 generates an output having a first gear reduction ratio. And in turn, the convex arc members 341 of the cam surface 34 on the outer surface of the ring gear 24 push the rollers 31 to contact the contour surfaces 331 in the wells 33. Thus, force is transmitted to the roller grooves 32. As a result, the planetary carrier 23 generates an output having a second gear reduction ratio. Therefore, an output rotation for driving the planetary carrier 23, which forming the roller grooves 32, as a second gear reduction ratio is generated. The planetary carrier 23, as an idler, is confined by the cam surface 34, the rollers 31, the wells 33 and the roller grooves 32 of the second-stage gear reduction unit 30 in the force imparting process. As a result, an output rotation having a second gear reduction ratio is generated and the output rotation is to be used by the external power requirement terminal.

In view of above description, the first-stage gear reduction unit 20 and the second-stage gear reduction unit 30 of the fusion gear reducer of the invention have the advantages of greatly increasing gear reduction ratio in a limited space, forming the roller grooves 32 of the wave-driven speed reducer on the outer surface of the planetary carrier 23, functioning the planetary carrier 23 as the seat (or plate) of the roller grooves 32, forming the wells 33 on an inner surface of the housing 10, integrally forming the cam surface with the outer surface of the ring gear 24, simplifying the construction of the fusion gear reducer, and rendering a compact design.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A fusion gear reducer comprising:
a housing;
a first-stage gear reduction unit disposed in the housing, the first-stage gear reduction unit being an epicyclic gear train including a planet gears support, a sun gear as an input, a plurality of planet gears equally spaced around the sun gear and meshed therewith, and a ring gear disposed around the planet gears and meshed therewith; and
a second-stage gear reduction unit disposed in the housing, the second-stage gear reduction unit being a harmonic drive including a plurality of equally spaced rollers arranged as a circle, a plurality of roller grooves, a plurality of wells formed on an inner surface of the housing, and a cam surface formed on an outer surface of the ring gear wherein the roller grooves are disposed between the cam surface and the wells, and the rollers are rotatably disposed in the roller grooves and confined by the cam surface, the wells, and the roller grooves;
wherein the ring gear is an output of the first-stage gear reduction unit and an input for driving the second-stage gear reduction unit;
wherein the rollers rotate the roller grooves;
wherein the roller grooves are formed on an outer surface of the planet gears support; and
wherein the planet gears support is an output of the second-stage gear reduction unit.

2. The fusion gear reducer of claim 1, wherein the sun gear, the cam surface, and the rotation center of the roller grooves are configured to rotate around the common axis.

3. The fusion gear reducer of claim 1, wherein the roller grooves are disposed between the cam surface and the wells having the rollers disposed therein.

4. The fusion gear reducer of claim 3, wherein the rollers are pushed by the cam surface to partially dispose in the wells to rotate the roller grooves.

5. The fusion gear reducer of claim 4, wherein the cam surface has two arc members on two annular, outer edges respectively, and wherein the rollers are pushed by the arc members to partially dispose in the wells to rotate the roller grooves.

6. The fusion gear reducer of claim 2, wherein the roller grooves are disposed between the cam surface and the wells having the rollers partially disposed therein.

7. The fusion gear reducer of claim 6, wherein the rollers are pushed by the cam surface to partially dispose in the wells to rotate the roller grooves.

8. The fusion gear reducer of claim 7, wherein the cam surface has two arc members on two annular, outer edges respectively, and wherein the rollers are pushed by the arc members to partially dispose in the wells to rotate the roller grooves.
